(19) United States
(12) Patent Application Publication
(10) Pub. No.: US 2024/0416693 A1
(43) Pub. Date: Dec. 19, 2024

(54) Tow Bar

(71) Applicant: Vanderhall Motor Works, Inc., Provo, UT (US)

(72) Inventors: Stephen Hall, Draper, UT (US); Michael Hall, Provo, UT (US); Chandler Flinders, Orem, UT (US); Daniel Boyer, Springville, UT (US); Thomas Corie, Springville, UT (US)

(73) Assignee: Vanderhall Motor Works, Inc., Provo, UT (US)

(21) Appl. No.: 18/744,545

(22) Filed: Jun. 14, 2024

Related U.S. Application Data
(60) Provisional application No. 63/508,222, filed on Jun. 14, 2023.

(51) Int. Cl. B60D 1/167; B60D 1/64

(52) U.S. Cl. CPC B60D 1/167; B60D 1/64

(57) ABSTRACT

A tow bar system for towing a vehicle is described. The system includes a towing vehicle connection member with a first tongue for insertion into a hitch receiver of a towing vehicle. The system also includes a towed vehicle connection member with a second tongue for insertion into a hitch receiver of a towed vehicle. A bar is attached at one end through a first joint to the towing vehicle connection member and is attached at its other end through a second joint to the towed vehicle connection member. At least one of the first and second joints is configured to allow motion in both a horizontal and vertical direction. The system also includes a wiring harness held on the tow bar, having a forward connector adapted to connect to wires in the towing vehicle and a rearward connector adapted to connect to wires in the towed vehicle.

### CROSS-REFERENCE TO RELATED APPLICATION

The present application is a continuation-in-part of U.S. Provisional Application No. 63/508,222, filed 14 Jun. 2023, and entitled “Tow Bar.” The entire disclosure of this prior application is incorporated herein in its entirety.

### TECHNICAL FIELD

This application relates to towing and specifically to flat towing a vehicle.

### BACKGROUND

Vehicles are typically used for transporting people and goods. In some instances, however, vehicles themselves are transported to other locations. There are a number of ways of transporting vehicles which include loading them on a trailer, attaching one set of wheels to a trailer carriage, or towing the vehicle with all four wheels in contact with the road. This last method is typically referred to as “flat towing,” “dinghy towing,” or “four-down towing.”

To use flat towing, one must make sure the towed vehicle is compatible. Not all vehicles can be flat towed. Generally, manual transmission vehicles and some four-wheel-drive vehicles with a transfer case that can be shifted into neutral are suitable. Typically, a base plate needs to be installed on the towed vehicle, which is used to attach a tow bar. Safety chains or cables provide an extra level of security in case the tow bar fails. Supplemental braking systems may be required by law to ensure the towed vehicle can be safely stopped. The towed vehicle must have operational lights that sync with the towing vehicle's signals.

### SUMMARY

In a first aspect, the disclosure provides a tow bar system for towing a vehicle, which includes a towing vehicle connection member with a first tongue for insertion into a hitch receiver of a towing vehicle. The system also includes a towed vehicle connection member with a second tongue for insertion into a hitch receiver of a towed vehicle. A bar is attached at one end through a first joint to the towing vehicle connection member and is attached at its other end through a second joint to the towed vehicle connection member. At least one of the first and second joints is configured to allow motion in both a horizontal and vertical direction. The system also includes a wiring harness held on the tow bar, having a forward connector adapted to connect to wires in the towing vehicle and a rearward connector adapted to connect to wires in the towed vehicle.

In a second aspect, the disclosure describes a tow bar system attached between a towing vehicle and a towed vehicle. The system includes a towing vehicle connection member, which, itself, includes a first tongue for inserting into a hitch receiver on a back end of the towing vehicle. This member also includes a joint that allows rotation around an axis parallel to a line between the towing vehicle and the towed vehicle. The system also includes a bar, which, itself, includes a forward end configured to attach to the towing vehicle connection member in such a way to allow vertical pivot between the bar and the towing vehicle connection member. The bar also includes a joint that allows a horizontal pivot between the forward end and a rearward end of the bar. The system also includes a towed vehicle connection member, which includes a sleeve for receiving the rearward end of the bar. This member also includes a second tongue for inserting into a receiver hitch on a front end of the towed vehicle, and a joint that allows pivoting in a vertical direction between the second tongue and the sleeve.

Preferably, the towed vehicle is an electric vehicle powered by a battery. Also, the tow bar system also includes means for commands to be sent from the towing vehicle to the towed vehicle. Such commands can include activation of brake and turn signal lights, engagement of the towed vehicles brakes to assist in stopping the two vehicles, and engagement of motors on the towed vehicle to assist in moving the two vehicles, when needed.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a side view of a tow bar connecting a towed vehicle to a towing vehicle.

FIG. 2 is a perspective view of one embodiment of a tow bar.

FIG. 3 is a perspective view of one embodiment of a tow bar where the tow bar is removed from the towed vehicle.

FIG. 4 is a perspective view of a tow bar attached to a vehicle in preparation for towing.

FIG. 5 is a side view of a tow bar attached to a vehicle, with the tow bar in a substantially horizontal position.

FIG. 6 is a top view of a tow bar attached to a vehicle.

FIG. 7 is a front view of a tow bar attached to a vehicle.

FIG. 8 is a side view of a tow bar attached to a vehicle, with the tow bar in a substantially vertical position.

FIG. 9 is a side view of a tow bar attached to a vehicle, with the tow bar in a position for attaching the tow bar to a towing vehicle.

FIG. 10 is a side view of three tow bars connecting three towed vehicles to each other and to a towing vehicle.

FIG. 11 is a perspective view of the three pieces that make up an alternative embodiment of the tow bar system.

FIG. 12 is a perspective view of the three pieces in FIG. 11 assembled for use.

FIG. 13 shows the member that fits into a towing hitch of the towed vehicle.

FIG. 14 shows the bar that connects the member of FIG. 13 to the member of FIG. 15.

FIG. 15 shows the member that fits into the towing hitch of the towing vehicle and connects to the bar of FIG. 14.

FIGS. 16A, 16B and 16C illustrate the sequence for attaching the bar of FIG. 14 to the member of FIG. 15.

FIGS. 17A, 17B and 17C illustrate the degrees of movement offered by the member of FIG. 15.

FIG. 18 illustrates a towing vehicle with the tow bar system, including safety chains and a breakaway cable.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “vertical,” in phrases such as “vertical storage position,” is not intended to be exact, but merely generally vertical.

Electric vehicles run on battery power. Much like a conventional combustion engine vehicle, an electric vehicle is limited to traveling the distance allowed by the energy stored on board. A combustion vehicle stores its energy in the combustion fuel, while an electric vehicle stores its energy in a battery. Electric vehicles “fill” their energy reserves by charging their batteries. Batteries are charged through the input of electrical current to the battery. Often this electrical current comes from an external source, the vehicle is connected to a power source and the electric current charges the battery. Currently there are commercial and home chargers. Additionally, electric vehicles may charge their batteries through regenerative braking, as the brakes are applied current is produced and sent to the batteries.

Vehicles are typically sold in locations away from the locations where they are made. Vehicles are then transported in several ways to the sales locations. These transport methods include on cargo ships, trains, semi-trucks, and towed or trailered behind other vehicles.

A trailer on which vehicles are placed to be moved adds costs in materials and operation. A trailer is an additional initial cost for the system. Additionally, the trailer has operating costs: first, the maintenance cost for keeping the trailer in good working condition; second the additional cost in fuel for pulling the trailer. The trailer must be constructed so that it can support any vehicles placed on the trailer. This means that the frame, platform, axles, and tow mechanism must be strong enough to support the vehicles on the trailer. This strength translates to weight. Flat towing a vehicle eliminates the initial cost and the maintenance and operational cost of the trailer.

Trailering, also called flat towing or dingy towing is also used to transport vehicles from a storage location to a use location. Two common examples of situations for trailering are, pulling a car or other vehicle behind an RV, and taking an off-road vehicle to the location where the off-road vehicle will be used. Trailering a vehicle behind an RV is often used because RVs are used for getting to a destination and sleeping in. Once at a destination a smaller vehicle is better for traveling around a destination. Dedicated off road vehicles are designed to excel in off road situations. The same design elements that help a vehicle off road, lead to limitations on a highway. These limitations include not being designed for highway driving, which includes both functional design characteristics and legal characteristics. Flat towing an off-road vehicle reduces the things the off-road vehicle is not good at. Whatever, the reason, there are opportunities to flat tow a variety of vehicles.

Flat towing vehicles should enable quicker transitions from towing to driving. When the vehicles arrive at their destination, transitioning from towed to driving requires that the towed vehicle be disengaged from the tow bar. Disengaging the vehicle from the tow bar can be as simple as removing a hitch ball mount from a hitch receiver, along with safety chains and electrical cables.

The way in which the towed vehicle attaches to the towing vehicle is of great importance to the usefulness of the system. The towing mechanism needs to attach to the towed vehicle in a way that does not cause any damage to the towed vehicle. Improper attachment of a tow bar to a towed vehicle could result in damage such as pulling a part of the towed vehicle off. A properly attached system will support the bar and pull on a part of the vehicle that will not be damaged or removed. One option is to ultimately connect to the frame of the vehicle.

Electric vehicles have advantages and disadvantages for trailering. Currently, no electric vehicles are known to be compatible with flat towing. However, because an electric vehicle uses electronics to control acceleration and braking, an electric vehicle could be beneficial to flat tow.

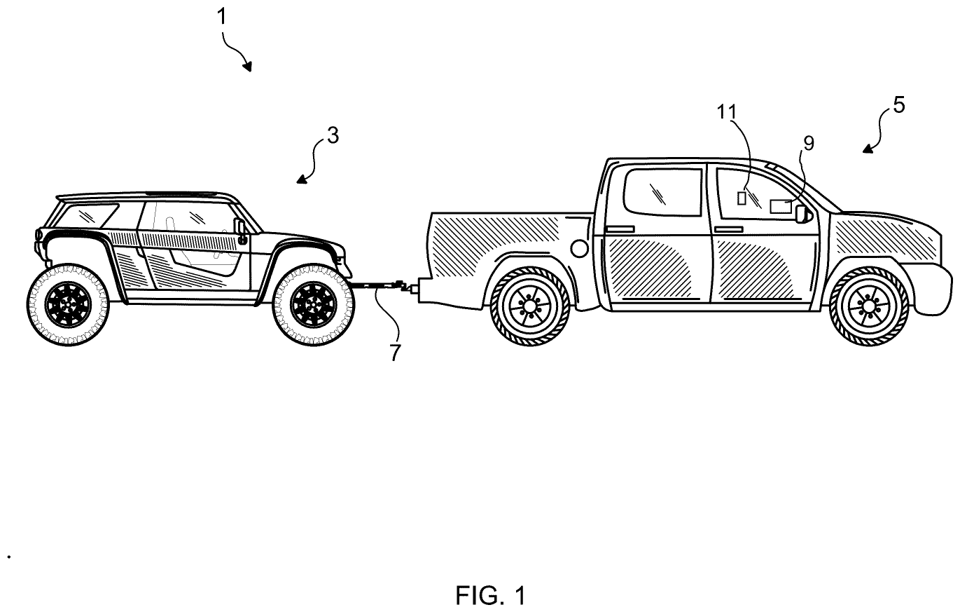

FIG. 1 depicts the tow bar system in use. In some embodiments, the towed vehicle is an electric vehicle. A towing vehicle 3 is attached to a first towed electric vehicle 5, by a tow bar 7. Preferably, the towing vehicle includes a digital user interface 9, which is configured to communicate with a smart device 11, such as a smart phone, through a system, such as Apple CarPlay® or Android Auto®.

The system is compatible with any manner of towing vehicles. The towing vehicle can be any vehicle rated to tow the weight of the vehicle or vehicles being towed. In some embodiments, the towing vehicle is a combustion engine vehicle. In some embodiments, the towing vehicle is a hybrid vehicle, in some embodiments, the towing vehicle is an electric vehicle. A larger towing capacity enables towing larger vehicles or greater numbers of vehicles. Currently, there are more internal combustion engine vehicles capable of towing large amounts, than there are electric vehicles capable of towing large amounts. A non-street legal off road electric vehicle, such as a Vanderhall Brawley® weighs between 2,700 and 3,000 lbs, a Tesla model 3 weighs between 3,648 and 4,250 lbs. Therefore, the towing vehicle must be able to tow at least 2,700 lbs. A vehicle that is configured to tow 5,400 lbs could tow one Tesla model S long range or two Vanderhall Brawley electric vehicles.

The tow bar system also includes electric communication between the towing and the towed vehicles. Often, the towing vehicle will be equipped with a connector or terminal to which a wiring harness on the tow bar attaches. The wiring harness passes electrical signals through the tow bar to the towed vehicle. The towed vehicle will also be equipped with a connector or terminal which connects to the wiring harness. Alternatively, signals may be passed between the towing and towed vehicles wirelessly, such by Bluetooth® or WiFi.

Electric vehicles include a vehicle control system, sometimes referred to as the vehicle control module or VCM. In the preferred embodiment, the tow bar system includes means for two-way communication between the towing vehicle and the VCM of the towed vehicle.

The Vehicle Control Module (VCM) in an electric car is a central component of the vehicle's electronic control system. It coordinates and manages various subsystems to ensure optimal performance, safety, and efficiency. The VCM serves as the brain of the electric vehicle (EV), integrating data from multiple sensors and control units to make real-time decisions. The functions of the VCM can be described as follows.

Power Management, also referred to as the Battery Management System (BMS), including
Battery Monitoring for the state of charge (SOC), state of health (SOH), and temperature of the battery pack.
Energy Distribution, controlling the flow of electrical energy between the battery, motor, and auxiliary systems.
Regenerative Braking to optimize the recovery of kinetic energy during braking and its conversion into electrical energy.

Motor Control, including
Torque Management to regulate the torque output of the electric motor based on driver input and road conditions.
Efficiency Optimization by adjusting motor parameters to achieve the best possible efficiency and performance.

Thermal Management, including
Cooling Systems to control the operation of cooling systems for the battery, motor, and power electronics to maintain optimal operating temperatures.
Heating Systems to manage cabin heating and battery preconditioning in cold weather.

Safety and Diagnostics, including
Fault Detection to continuously monitor system components for faults and takes corrective actions if necessary.
Diagnostics to provide diagnostic information for maintenance and troubleshooting.
Emergency Protocols to implement safety protocols in case of critical failures, such as isolating the battery in case of a crash.

Driver Assistance and User Interface, including
Drive Modes to engage different driving modes (e.g., eco, sport) to tailor performance to the driver's preferences.
Dashboard Integration to communicate with the vehicle's infotainment and instrument cluster to display relevant information to the driver.

User Controls: Processes input from the driver (e.g., accelerator, brake, steering) and translates it into appropriate actions.

Connectivity and Communication, including
CAN Bus Communication, making use of the Controller Area Network (CAN) bus to communicate with other electronic control units (ECUs) in the vehicle.
Telematics that integrate with telematics systems for remote diagnostics, software updates, and vehicle tracking.
Integration with External Systems to support integration with charging infrastructure, smart grid, and other external systems for coordinated energy management.

The components of the vehicle control system for an electric vehicle may include the following:

Microcontroller Unit (MCU), which acts as the processing unit for the VCM, running the control algorithms and processing sensor data. The MCU requires high processing power and reliability to handle complex computations and real-time control tasks.

Power Electronics, which manage the power flow between the battery, motor, and other electrical systems. These include inverters, converters, and relays.

Sensors, including sensors for temperature, voltage, current, speed, position, and more. These sensors provide real-time data necessary for the VCM to make informed decisions.

Communication Interfaces, including the CAN Bus, which is the standard communication protocol for automotive systems. Other Interfaces may include Ethernet, LIN bus, and wireless communication modules. The communication links may be direct or indirect. A direct link may include a link between two devices where information is communicated from one device to the other without passing through an intermediary. For example, the direct link may include a wired connection, a Bluetooth® connection, a ZigbeeR connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links, may refer to any of the described communication links.

The battery management system further includes a processor, memory, various sensors, and a communication device. The motor control system further includes a processor also known as a motor controller, memory, and a communication device. The steering control system includes a processor, memory, and a communication device. The body control system includes a processor, memory, and a communication device.

Various of the vehicle control system elements may include a communication device, a memory device, and/or a processing device. Various of the communication, processing, and memory devices may be electronically connected by a system bus and/or on a common printed circuit board. The system bus may be and/or include a control bus, a data bus, an address bus, and so forth.

A processing device of the vehicle control system handles inputs and/or generates outputs. The processing device causes data to be written and stored in the corresponding memory device based on the inputs. The processing device retrieves data stored in the memory device, performs various computations based on instructions stored in the memory device, and outputs data and/or instructions to another element of the vehicle control system via the communication device. The processing device determines, based on instructions and/or data stored in the memory device, what data and/or signals to output. For example, the processing device for the motor control system receives a signal corresponding to a motor input. In some embodiments, the signal received is to give an engine assist to the towing vehicle. The motor control system of one towed vehicle is adapted to pass that signal to the motor control system of any other vehicle connected to the wiring harness of a tow bar.

Though depicted separately, one or more of the control subsystems in the vehicle control system are in some embodiments, integrated together. For example, the steering control system and the motor control system are often integrated as a single system, utilizing the same processing device, memory device, and communication device. In some implementations, the steering control system is integrated partly with the motor control system and partly with the body control system.

In some embodiments, a processing device of the vehicle control system includes volatile and/or persistent memory. In some embodiments, a memory device of the vehicle control system has volatile and/or persistent memory. In some embodiment, the processing device has volatile memory, and the memory device has persistent memory.

In some embodiments, the processing device includes at least one of a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the described devices, elements, and/or features of the processing device.

In some embodiments, the memory device is or includes a computer processing unit register, a cache memory, a magnetic disk, an optical disk, a solid-state drive, and so forth. In some embodiments, the memory device is configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the described devices, elements, and/or features of the memory device.

Various elements of the vehicle control system include data communication capabilities. In some embodiments, such capabilities are rendered by various electronics for transmitting and/or receiving electronic and/or electromagnetic signals. The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth® programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the described elements and/or features of the communication component.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer readable. Data may refer to human-readable text.

In some embodiments, various elements of the vehicle control system include a user interface for outputting information in a format perceptible by a user and receiving input from the user. In some embodiments, the user interface includes a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. In some embodiments, the user interface further includes an acoustic element such as a speaker, a microphone, and so forth. In some embodiments, the user interface includes a button, a switch, a keyboard, a touch sensitive surface, a touchscreen, a camera, a fingerprint scanner, and so forth. In some embodiments, the touchscreen includes a resistive touchscreen, a capacitive touchscreen, and so forth.

The towing system includes a tow bar for attaching the towing vehicle to the towed vehicle. The towing vehicle may attach to the tow bar in a variety of ways. In some embodiments, the towing vehicle will include a hitch receiver, that will accept a hitch ball. The tow bar will attach to the hitch ball via a hitch ball mount. In other embodiments, a towing apparatus such as those used to tow fifth wheel trailers will attach to the towing vehicle, and the tow bar will attach to that towing apparatus. In some embodiments, a commercial towing apparatus such as those used by commercial semi-trucks will attach to the towing vehicle and the tow bar will attach to that apparatus. In some embodiments, the towed vehicle will attach without the tow bar.

The towed vehicle includes a mechanism for attaching to the tow bar. In some embodiments, the towed vehicle includes a hitch receiver attached to the front of the towed vehicle. The hitch receiver needs to be attached in a location that will enable the vehicle to be towed without damaging the vehicle. Typically, attaching the hitch receiver to the frame will be the most secure. In some vehicles attaching to another location will also result in a secure attachment point.

The towed vehicle also includes an adapter or terminal for attaching a wiring harness of the tow bar to. In some embodiments, this is a seven-pin connector. The wiring harness may pass commands as electric signals from the towing vehicle to the towed vehicle. The commands will initiate actions in the towed vehicle. In some embodiments, the actions of the towed vehicle echo the actions of the towing vehicle. The towed vehicle does the same action as the towing vehicle. Examples of echoing actions include actions of the lighting system, such as turn signals and brake lights.

In certain embodiments, the towed vehicle will echo the actions of the towing vehicle. Electric vehicles are uniquely capable of receiving direction from an outside source. Most electric vehicles rely on electric signals to control the actions of the disparate parts of the vehicle. As described earlier, the electric vehicle includes systems that control the functions of the vehicle. One of those systems is a motor control system. The motor control system controls the motors which turn the wheels to move the vehicle. This means that instead of a physical connection to the accelerator, where the accelerator pedal in an internal combustion vehicle is physically linked to the throttle, the accelerator pedal in an electric vehicle sends an electric signal to the motor to turn faster. Similarly, the brake pedal of an internal combustion engine vehicle are physically connected to the brakes, where the brakes in an electric vehicle are connected electrically. This means that the electric vehicle can receive an electric signal to apply the brakes, or even an electric signal to turn the motor. Taking advantage of this aspect of the design and construction of electric vehicles, the wiring harness that connects the towing vehicle to the towed vehicle may enable a signal from the towing vehicle to be received by the motor control system, and directly affect the towed vehicle. Modern vehicles utilize computers and computing systems to improve the functions throughout a vehicle. Electric vehicles especially use computers and computing systems to run all the functions of the vehicle. Many electric vehicles do not have physical connections to control systems. For example, a combustion engine vehicle uses levers and cables to control the throttle and brakes. In contrast, many electric vehicles rely on electric signals to control the throttle and brakes. The computing systems send commands to each system, based on the input from the driver.

In some embodiments, the lighting system of the towed vehicle will echo the lighting system of the towing vehicle. For example, when the brake pedal in the towing vehicle is pressed, a switch is activated which turns the brake light on, additionally a signal will be sent through the wiring harness to the brake lights of the towed vehicle. Another example, the towing vehicle signals a left turn. When the signal lever is articulated the switch turns on the left turn signal, and a signal will be sent through the wiring harness to the left turn signal lights of the towed vehicle.

In some embodiments, the towed vehicle will receive a command for an additive action for one of its systems These additive actions may include a brake assist and an engine assist. In certain situations, such as going up a hill with a steep grade, the towing vehicle will send a command to the motor control system of the towed vehicle to engage the motors. This will provide an assist to the vehicle system and help the towing vehicle up the hill. The engine of the towing vehicle includes sensors. Theses sensors connect to the Engine Management System (EMS) which monitors and controls the engine. One component of the EMS is the Engine Control Unit (ECU) which includes a CPU and software. The CPU receives the input from all the engine and other vehicle sensors and makes adjustments to the engine systems based on software parameters. The ECU unit of the towing vehicle is programmed to send the engine assist command when the conditions require it. Additional situations for the engine assist include muddy or snowy conditions.

In some embodiments, the additive action is a brake assist. In some embodiments, the towing electric vehicle will provide all the braking power needed for stopping the towing vehicle and the towed vehicle. In some situations, it would be beneficial to have the towed vehicles provide a brake assist. Such situations include steep descents, descents with tight turns, roads having slippery conditions, and other situations. In certain situations, a towing vehicle may need to stop quickly. In these situations, the driver of the towing vehicle will urgently press the brakes, this will pass the brake command to the brake system of the towed vehicle and the brakes of the towed vehicle will engage, assisting the towing vehicle in stopping the towing vehicle system. The brake system can be programed such that the brakes on the towed electric vehicle will only activate in situations where the brake assist is necessary.

Regenerative braking enables the battery of the towed electric vehicle to be recharged as the brakes are applied. The brakes of the towed electric vehicle can be adapted to engage when the towing vehicle is in motion. By engaging the brakes of the towed vehicle, the brakes are continuously or periodically engaged while the vehicle is being towed, this gives provides a chance for the regenerative braking system to charge the batteries of the towed electric vehicle. It is noted, however, that if the towed vehicle's battery is fully charged, that it cannot use regenerative braking to slow the vehicle. For this reason, it may be preferable to include mechanical brakes on the towed electrical vehicle, which mechanical brakes can still be engaged by an electric signal. For example the mechanical brakes may function with electrically powered servos to apply pressure to the brake pads.

In addition to signal lights, brake and motor assist, a towed electric vehicle with independently controlled motors for each wheel, such as the Vanderhall® Brawley™, can also be given commands to execute turning by differential speed to each wheel. See, for example, co-pending application Ser. No. 18/166,428, published as 2023-0278627 and entitled “Vehicle with Normal and Differential Steering Modes.” Thus, if the towing vehicle and towed vehicle need to make a particularly tight turn, the differential speed steering in the towed vehicle can be engaged.

Another function of the electric harness of the tow bar system may be to pass power between the towing vehicle and the towed vehicle. For example, if the towing vehicle is also an electric vehicle with a good charge in its batteries, power may be passed through the tow bar system to charge the batteries of the towed vehicle. Alternatively, if the towed vehicle has a good charge in its batteries, and the range of the towing vehicle can be extended, power can be passed from the towed vehicle to the towing vehicle to do so. Of course, any such passing of power is controlled by the battery management systems in both vehicles, to prevent any damage or unsafe conditions in both vehicles.

In some embodiments, the towing vehicle communicates commands to the towed vehicle(s) without interaction from the driver or passengers in the towing vehicle. In other words, the towing vehicle's vehicle control unit (VCU) or vehicle control module (VCM), automatically sends a signal to the towed vehicle when a brake assist or motor assist is needed. Certainly the brake lights and turn signals are communicated automatically.

In other embodiments, the driver may initiate a command, such as brake assist or motor assist, sent to the towed vehicle. This may be accomplished by putting a driver input device on the dash of the towing vehicle. Preferably, the driver input device is the driver's smart phone. More preferably, that smart phone is connected through a system such as Apple CarPlay® or Android Auto®, so as to provide a heads-up display and interface for the driver. Preferably, the system can also communicate the status of the towed vehicle, such as state of charge for an electric vehicle. The display may also confirm that brake lights and turn signals are operational.

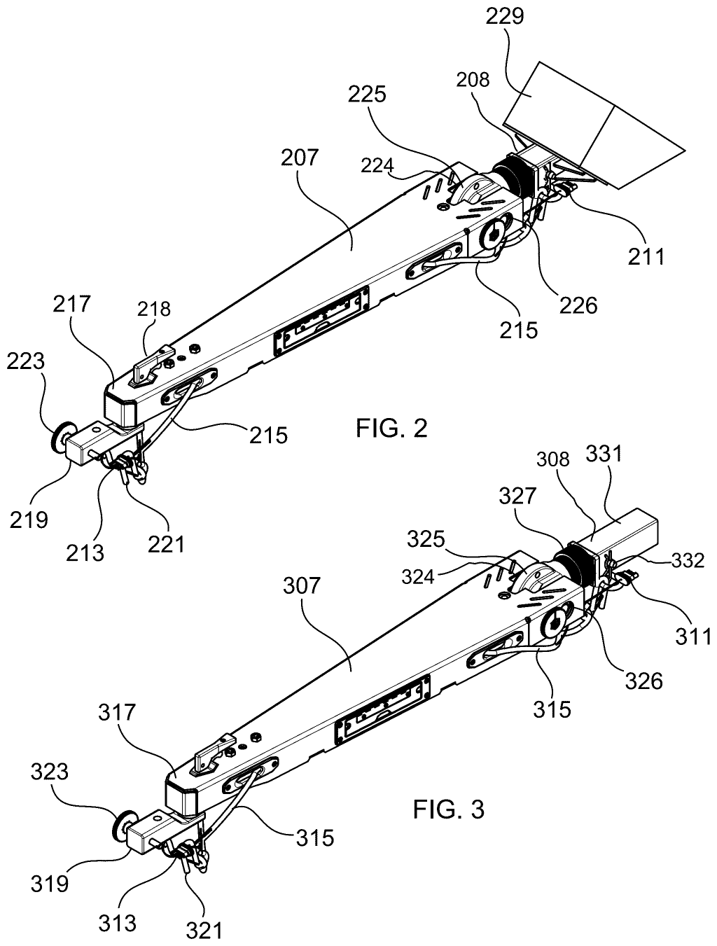

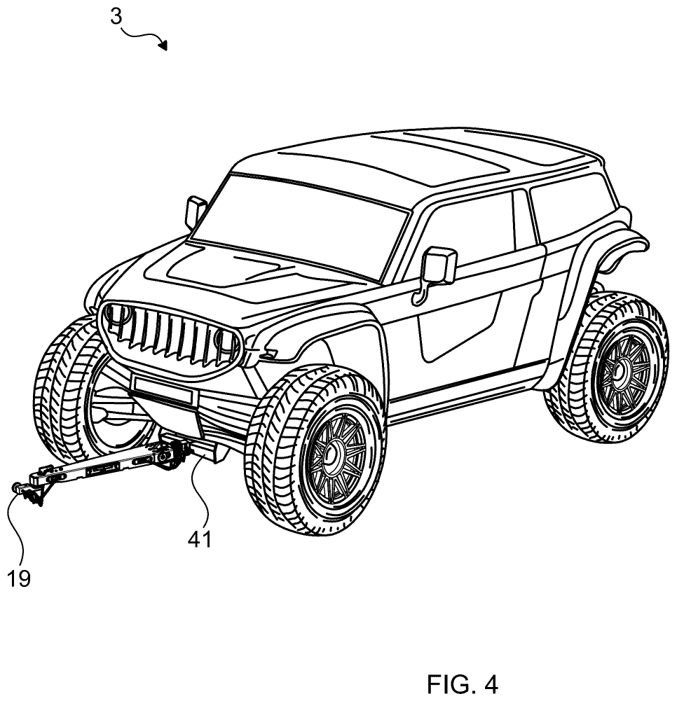

FIGS. 2 and 3 are depictions of the tow bar. FIG. 2 depicts an embodiment where the tow bar is attached as a permanent fixture to the towed electric vehicle. FIG. 3 depicts an embodiment where the tow bar attaches to a hitch receiver connected to the towed electric vehicle.

Referring to FIG. 2, the tow bar is permanently affixed to the front of a towed electric vehicle. The tow bar provides a mechanical and electrical connection between the towing vehicle and the towed vehicle. The electrical connection includes a connector 211 for the towing vehicle and a connector 213 for the towed vehicle and a wire harness 215 connecting the connectors. There are multiple connectors that could be utilized to connect to the towing vehicle. In one embodiment, the connector is a seven-pin connector.

The tow bar is constructed in two main parts, a first member 207 and a second member 208. The first member includes a hitch ball attachment portion 217 at its forward end for receiving a hitch ball of a towing vehicle. A wiring harness 215 is secured to the first member, and in some embodiments is secured within the first member. The rearward end of the first member includes a channel 224 through which a disk 225, on the second member, passes. The first member 207 and second member 208 are hingedly attached together by an axle. The hinged attachment configuration enables the first member to rotate around the hinged axis 226. By rotating about the hinged axis 226, the first member 207 is able to move from a substantially horizontal configuration to a substantially vertical configuration. The second member also includes a disk 225. This disc 225 provides locking positions for the first member to be secured in place. As the first member is rotated about the hinge axis 226, or the axle the channel 224 of the first member travels around the disk 225. The first member 207 is configured to be locked into different positions. Such positions include but are not limited to a horizontal position and a vertical storage position.

The rotational articulation, or hinging action, enables direction of pull on the towing vehicle to remain horizontal. When the hinge of the tow bar is in an unlocked position, the first member can rotate around the hinge, the hinge is point from which the pull emanates. When the rear of the towing vehicle is above the towed vehicle, the articulation axle 225 will enable the first member 207 of the tow bar to angle upward. When the rear of the towing vehicle is below the towed vehicle, the articulation axle 225 will enable the first member 207 of the tow bar to angle downward. This articulation keeps the pulling force on the towed vehicle more consistent. The rotational articulation, or hinging action, also enables the first member 207 of the tow bar to be positioned vertically when not in use. The first member 207 of the tow bar locks to the disk 225 in the vertical position. The tow bar will not drop to the ground nor fall against the vehicle. Both options are potentially dangerous and damaging to the vehicle. In addition to vertical differences between the rear of the towing vehicle and the front of the towed vehicle, there are horizontal differences as well.

In some embodiments, a hitch ball assembly 219 includes specific configurations to optimize use with the tow bar. These configurations include a wire harness hook 221. A receiver pin 223 ensures that the hitch ball assembly 219 will not pull out of the hitch receiver. A convention lock 218 is used to keep the hitch ball in the socket.

The tow bar provides the mechanical connection between the towing and towed vehicle. The first member and the second member of the tow bar along with the long bar connecting them need to be able to withstand the forces placed on them. The tow bar will primarily be in tension. Therefore, materials that are capable of withstanding the tensile forces of being in tension will be best for the tow bar. Some examples of such materials are steel, stainless steel, titanium, carbon fiber, and fiber reinforced plastics. Most commonly steel and stainless steel will be used in the construction of the first member, second member, and bar or axle of tow bar. When steel is used it is useful to protect the steel. Methods of protecting the steel include painting, powder coating, and galvanization. In some embodiments, the first member and the second member are constructed of carbon fiber or reinforced plastics. In such embodiments, the axle is constructed of a metal.

Referring to FIG. 3, where the tow bar is attached to the towed vehicle with a hitch receiver at its front. The tow bar provides a mechanical and electrical connection between the towing vehicle and the towed vehicle. The electrical connection includes a connector 311 for the towing vehicle and a connector 313 for the towed vehicle and a wire harness 315 connecting the connectors. There are multiple connectors that could be utilized to connect to the towing vehicle. In one embodiment, the connector is a seven-pin connector.

The tow bar is constructed in two main parts, a first member 307 and a second member 308. The first member 307 includes a hitch ball attachment portion 317 at its forward end for receiving a hitch ball of a towing vehicle. A wiring harness 315 is secured to the first member, and in some embodiments is secured within the first member. The rearward end of the first member includes a channel 324 through which a disk 325, on the second member, passes. The second member 308 includes a hitch tongue 331 at its rearward end configured to be inserted or received in a hitch receiver of the towed vehicle. The hitch tongue is secured with a hitch pin 332. Additional stability is provided by a stability collar 327. The stability collar 327 is rotated to tighten it against the hitch receiver. Tightening the stability collar reduces the amount give between the hitch receiver on the towed vehicle and the tongue on the tow bar. The tongue is manufactured to fit within the receiver, and manufacturing tolerances are designed so that the tongue is smaller than the receiver so that the tongue will more easily slide into the receiver. This is good for initial installation of the tow bar tongue to the hitch receiver but allows some play in the system. The stability collar reduces the amount of play and assists in providing a more secure attachment of the tow bar to the hitch receiver. The first member 307 and second member 308 are hingedly attached together by an axle. The hinged attachment configuration enables the first member to rotate around the hinged axis 326. By rotating about the hinged axis 326, the first member 307 is able to move from a substantially horizontal configuration to a substantially vertical configuration. The second member also includes a disk 325. This disc 325 provides locking positions for the first member to be secured in place. As the first member is rotated about the hinge axis 326, or the axle the channel 324 of the first member travels around the disk 325. The first member 307 is configured to be locked into different positions. Such positions include but are not limited to a substantially horizontal position and a substantially vertical position.

In some embodiments, a hitch ball assembly 319 includes specific configurations to optimize use with the tow bar. These configurations include a wire harness hook 321. A receiver pin 323 ensures that the hitch ball assembly 319 will not pull out of the hitch receiver of the towing vehicle.

FIG. 4 is a partial front view which depicts an electric vehicle with a tow bar attached and extended. In this configuration the electric vehicle is prepared to be attached to a towing vehicle. The tow bar is attached to a hitch receiver 41 at the front of the towed vehicle. Preferably, the hitch receiver is permanently affixed to the vehicle. In this embodiment, the tow bar include a hitch ball assembly 19, which is adapted to be inserted into the hitch receiver of the towing vehicle. Alternatively, the tow bar works with a hitch ball already installed on the towing vehicle.

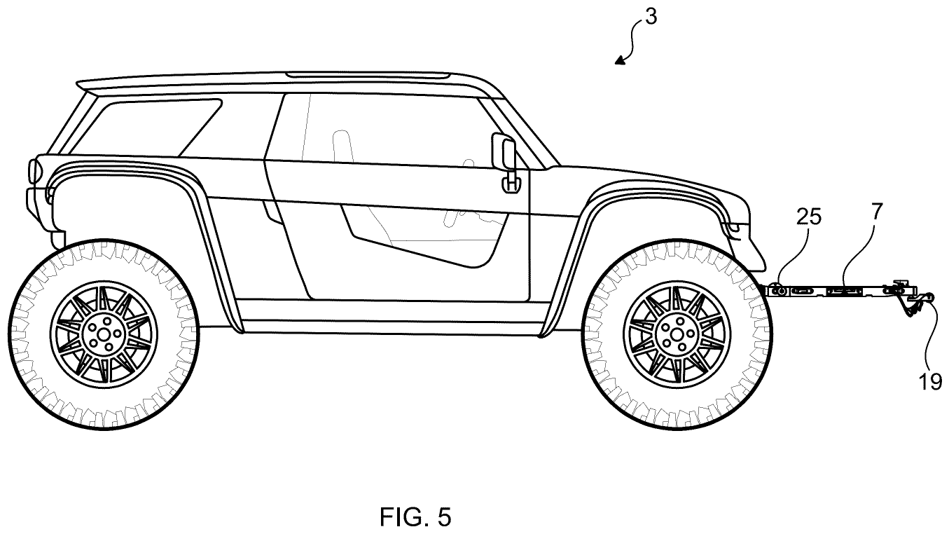

FIG. 5 is a side view of the tow bar attached to a vehicle 3. The first member 7 is in a substantially horizontal position, ready to be attached to a towing vehicle. The articulation or hinging action around the hinge axis enables the towing vehicle and the towed vehicle to be at different relative heights. The hinging action around the hinge axis also helps as the vehicles transition across roads with different grades. For example, as the towing vehicle travels from a flat road to an inclined road the hinging action keeps the towed vehicle level without lifting the front of the towed vehicle. Keeping the towed vehicle as level as possible puts less stress on the chassis, frame, and shocks of the towed vehicle.

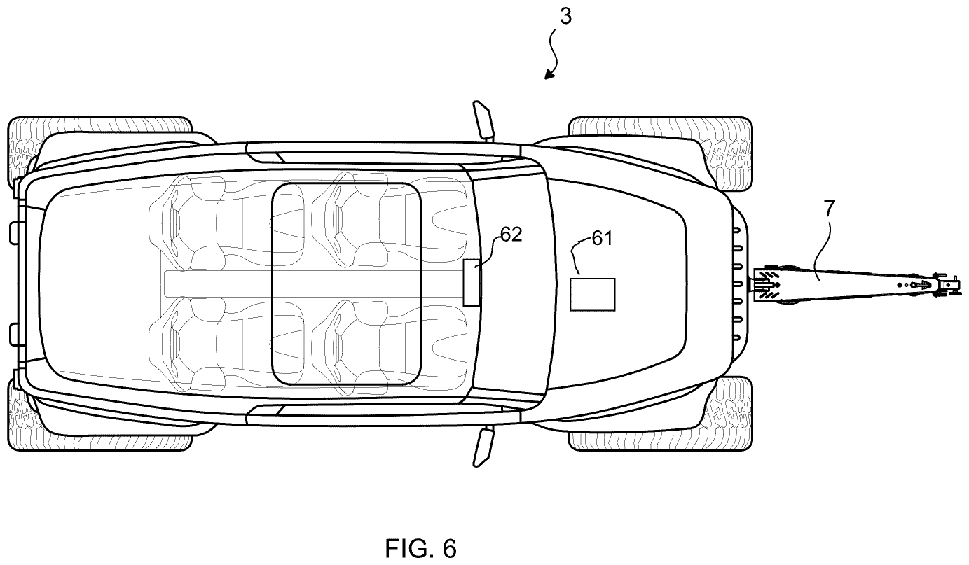

FIG. 6 is a top view of a vehicle 3 with a tow bar attached. The first member 7 is in a substantially horizontal position ready to be attached to a towing vehicle. Vehicle control module 61 may be under the hood. Also, a digital user interface, 62, may be attached in the dashboard of the vehicle. Such an interface preferable uses technology, such as Apple CarPlay® or Android Auto® to communicate with a smart device.

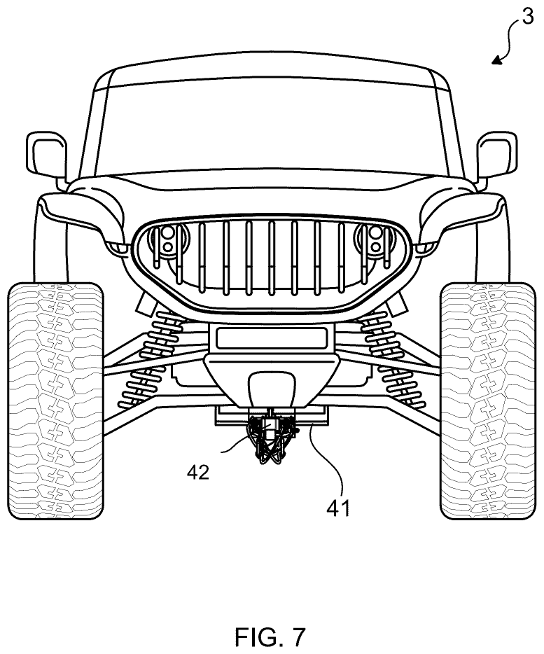

FIG. 7 is a front view of an electric vehicle with a tow bar 42 system attached. In this embodiment, the tow bar is attached to a hitch mount receiver 41. Attaching to a hitch mount receiver allows the tow bar to be attached for towing and removed for use once a destination has been reached.

FIG. 8 is a side view of a towed vehicle with the first member 7 of the tow bar in a substantially vertical storage position. The hinging action of the hinge axis 25 allows the first member 7 to rotate or move rotationally. Thus, changing the orientation of the first member. In this embodiment, the first member 7 of the tow bar is rotated to a substantially vertical position so that it is out of the way of the normal use of the vehicle. Additionally, the first member 7 of the tow bar can be locked in the substantially vertical position so that it will not fall and get in the way of the vehicle or damage the vehicle. The exact positioning of the first member of the tow bar in the substantially vertical position may not be exactly 90°, this is because the positioning of the first member of the tow bar is dependent on several factors. Such factors include the positioning of the hitch receiver assembly and the bumper assembly of the vehicle. In some embodiments, it may be advantageous to rotate the first member of the tow bar further toward the vehicle keeping the bar further out of the way of obstacles and further out of the sight lines of the driver. In some other embodiments, it may be advantageous to rotate the first member of the tow bar further away from the front of the vehicle, providing a larger distance to the front of the vehicle, while keeping the first member out of sight of the driver.

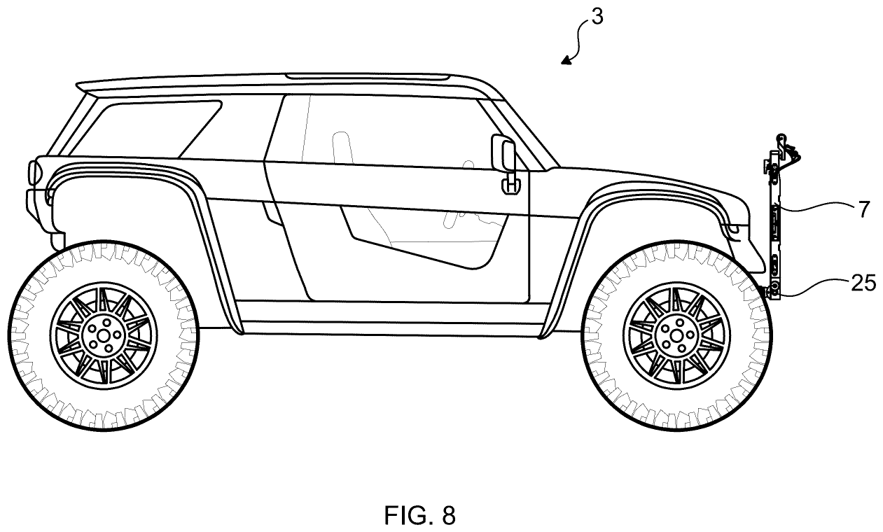

FIG. 9 is a side view of a towed vehicle with the first member 7 of the tow bar in a position to facilitate the attachment of the tow bar to a towing vehicle. The hinging action of the hinge axis 25 allows the first member 7 to rotate or move rotationally. Thus, changing the orientation of the first member. In this embodiment, the first member 7 of the tow bar is rotated to a position to facilitate the attachment of the tow bar to a towing vehicle. Attaching a tow bar to a towing vehicle is often a two-person job. The tow bar is out of sight of the person driving the towing vehicle, so another person gives instructions to the driver. Additionally, the tow bar is typically very close to the same height as the hitch of a towing vehicle. By locking the tow bar in a slightly elevated position, the hitch ball can be positioned underneath the tow bar without the hitch ball hitting the tow bar. Also, with the prevalence of back-up cameras on vehicles it is possible for a driver to see with better clarity the tow bar, and thus position the hitch ball beneath the tow bar. Being able to lock the tow bar in the position to facilitate attachment is also quicker than other systems which typically have a crank to raise and lower a jack attached to a towing mechanism. The rotatable tow bar eliminates this time-consuming step and enables quicker transitions for attachment of the towing vehicle.

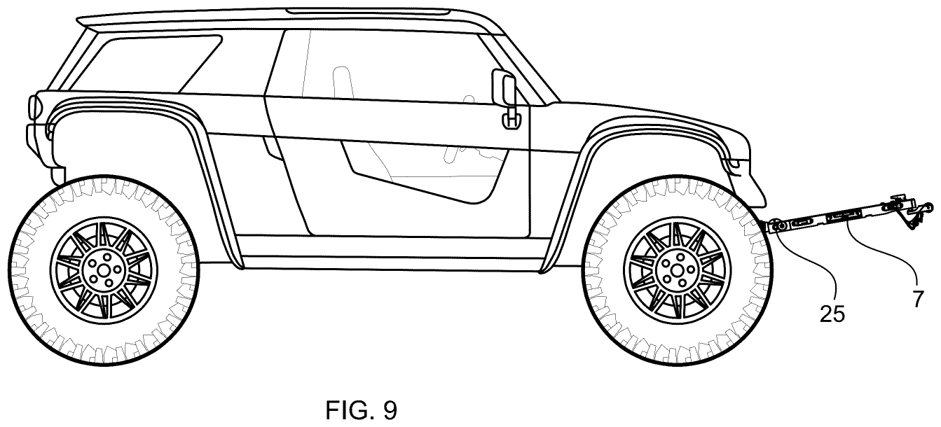

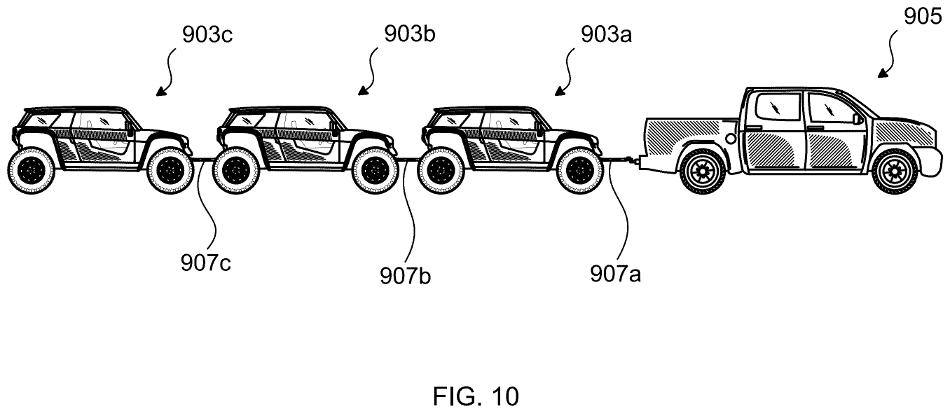

FIG. 10 is a side view of three vehicles being towed. In some embodiments the towing vehicle 905 may tow more than one vehicle. This is especially useful for transporting vehicles to a sales location. A manufacturer needs to move vehicles to a dealer so the vehicles can be sold. There is no limit on the number of vehicles that can be towed aside from the towing capacity of the towing vehicle. The ability to tow multiple vehicles depends on the weight of the vehicles being towed and the towing capacity of the towing vehicle. For example, a non-street legal off road electric vehicle, such as a Vanderhall Brawley weighs between 2,700 and 3,000 lbs, a Tesla model 3 weighs between 3,648 and 4,250 lbs. Therefore, the towing vehicle must be able to tow at least 2,700 lbs. A vehicle that is configured to tow 5,400 lbs could tow one Tesla model S long range or three Vanderhall Brawley electric vehicles. A vehicle with a towing capacity of 15,000 lbs could tow three Tesla model S's, or five Vanderhall Brawleys.

In the embodiment depicted in FIG. 10, the towing vehicle 905 is towing three vehicles 903a, 903b, and 903c. Tow bar 907a connects the towing vehicle 905 to the first towed vehicle 903a. Tow bar 907b connects the first towed vehicle 903a, to the second towed vehicle 903b. Towbar 907c connects the second towed vehicle 903b to the third towed vehicle 903c. As has been described above, the tow bars provide a physical and electric connection between the vehicles. The wiring harness in the tow bars enable the electrical signals and commands to be passed through each tow bar to each of the towed vehicles. The towed vehicles are similarly configured so that the electric signals pass on through the towed vehicles. The signal will be passed to each of the towed vehicles and each vehicle will initiate the commands received. In some circumstances this will be an echo of the actions of the towing vehicle and in some circumstances, it will be an additive action to assist the towing vehicle.

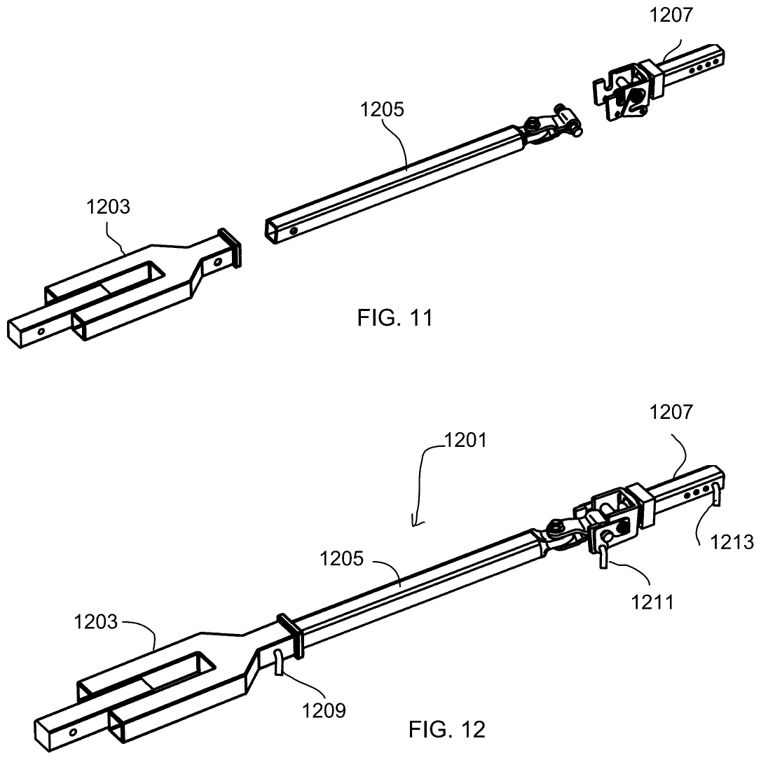

FIGS. 11 and 12 depict an alternative embodiment of the tow bar system 1201 that is made up of three pieces. A significant difference between this embodiment and the one depicted above, see, e.g. FIGS. 2 and 3, is that the embodiment discussed above uses a convention hitch ball and socket to connect the tow bar system to the towing vehicle. While such an arrangement is preferred for its simplicity, there are situations wherein it is preferred to have a greater angular movement between the towing vehicle and the tow bar. For example, if the vehicle is being towed in rugged conditions, such as off-road trails, it is preferred that the joint between the towing vehicle and the tow bar be able to pivot through larger angles, both vertically and horizontally. Preferably, the joint allows a horizontal pivot of at least 120 degrees and a vertical pivot of at least 90 degrees. Even more preferably, the joint will allow rotation about an axis parallel to a line between the towing vehicle and the towed vehicle. This ability to rotate allows the towing vehicle and towed vehicle to go over rough terrain, where the plane of the wheels of one vehicle is not parallel, i.e. is twisted, with respect to the place of the wheels of the other vehicle.

Fortunately, a joint that provides these functions is commercially available from the company Lock N Roll, and named Articulating Trailer Hitch for 2″ Receivers-Vehicle Side-11,000 lbs, Item #336VS501 (see https://www.etrailer.com/Trailer-Hitch-Ball-Mount/Lock-N-Roll/336VS501.html). The part 1207 in the Figures below is this device from Lock N Roll.

FIG. 11 shows the pieces of this alternative embodiment separated, while FIG. 12 shows them pinned together for use. The piece that attaches to the towed vehicle is shown at 1203. The piece that attaches to the towing vehicle is shown at 1207, while the piece that connects these two is shown at 1205. Pins 1209 and 1211 are used to lock these three pieces together. Pin 1213 locks the tongue into the hitch receiver of the towing vehicle.

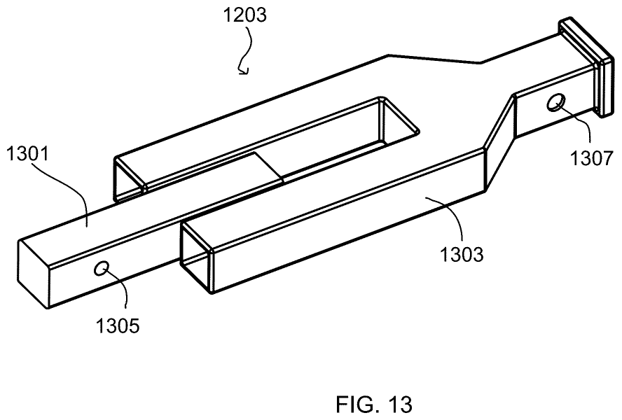

FIG. 13 illustrates the part 1203 that is used to attach to the towed vehicle. This is accomplished by inserting the tongue 1301 into the hitch receiver at the front of the towed vehicle. A pin is inserted through a hole the hitch receiver sleeve and the hole 1305 in the tongue. The tongue is pivotally mounted through an axle (not shown) held by the two sides of the fork 1303. Because the tongue pivots, the tow bar is able to swing vertically. In this way, the relative height of the towing and towed vehicles can change. It also allows the tow bar to be swung upward into a vertical storage position. Part 1203 also includes a sleeve at one end, for insertion of the elongated bar. That bar is held by inserting a pin through the hole 1307.

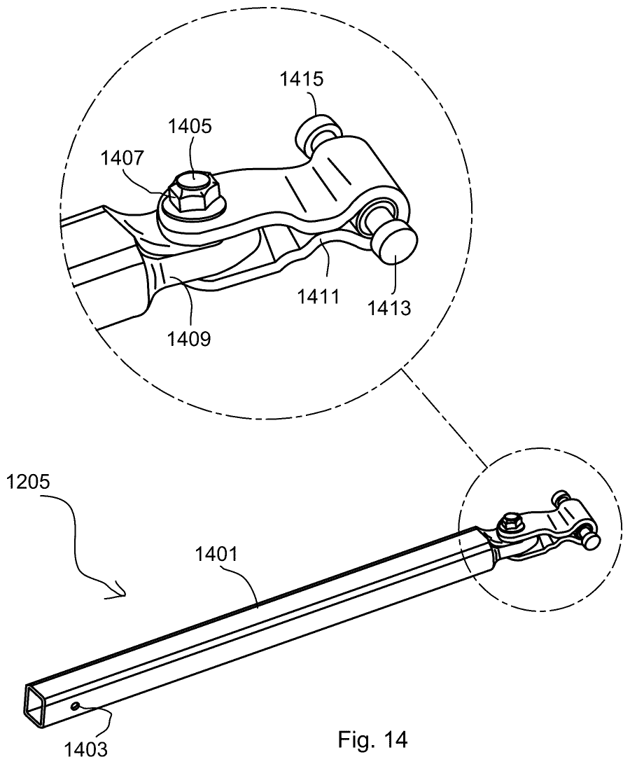

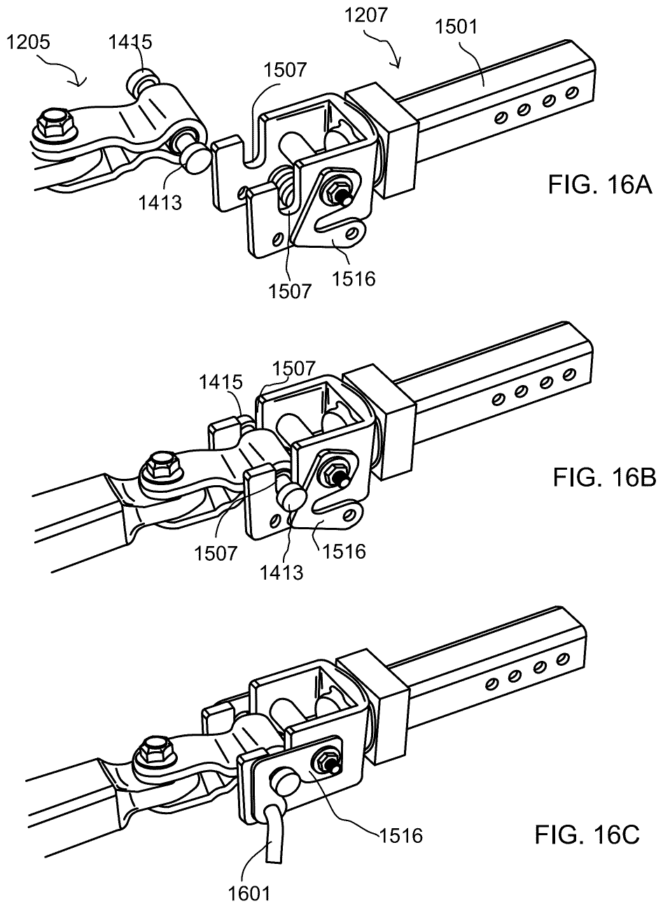

FIG. 14 illustrates the long bar 1205 that spans between the connecting parts at both ends. The bar includes an elongate section 1401 and a hole 1403 at one end through which a pin is inserted to lock the bar inside the sleeve of the part 1203 shown in FIG. 13. At the other end, there is a drawn part 1409, through which a bolt 1405 passes and is secured by nut 1407. The bolt also passes through a hole is both sides of the bracket 1411, which bracket is free to pivot about the bolt 1405. At the other end of the bracket 1411, a rod with ends 1413 and 1415 is captured. These ends will be used to attached to the next part as shown in FIGS. 16A-C.

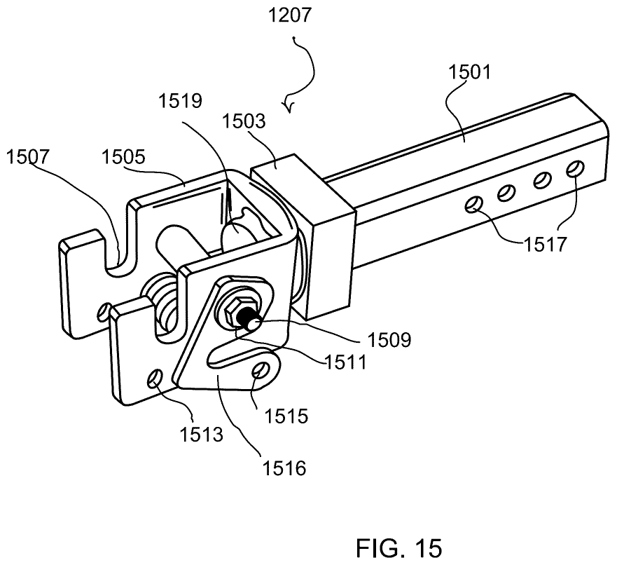

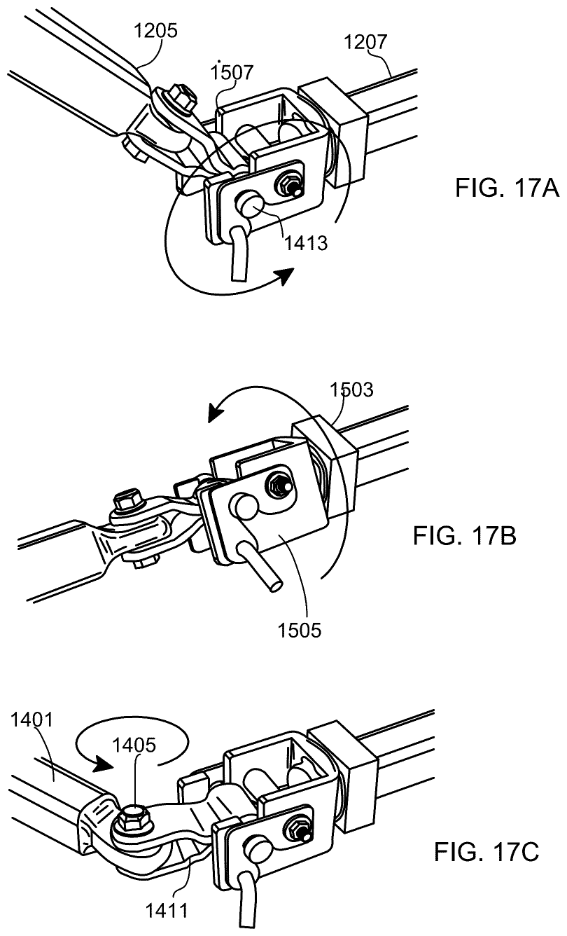

FIG. 15 depicts the part 1207 that connects to the towing vehicle in this alternative embodiment. This part includes a tongue 1501 that is adapted to be inserted into the hitch receiver of the towing vehicle. Holes 1517 are provided for pinning the tongue within the sleeve. Multiple holes are provided in order to account for different insertion depths, depending on the make of the hitch receiver. The tongue 1501 is fixedly attached to a block 1503. The bracket 1505 is attached to the block 1503 through a journal 1519, which journal allows the bracket 1505 to rotate about an axis parallel to a line between the towing and towed vehicles, see FIG. 17B. This rotation allows the towed vehicle to twist with respect to the towed vehicle. The bracket 1505 includes two slots 1507 for receiving the ends 1413 and 1415 of the part 1205 of FIG. 14. This connect is illustrated in FIGS. 16A-C below. A bolt 1509, secured by a nut 1511, passes from one side to the other of the bracket 1505 and holds a locking part 1516 on each side of the bracket. As seen in FIG. 16C, one the ends 1413 and 1415 are received in the slots 1507, the locking parts 1516 are pivoted over the ends and locked in place by a pin inserted through the holes 1513 and 1515.

FIGS. 16A-C depict the sequence of joining parts 1205 and 1207. As shown in FIG. 16A, the part 1205 is brought near the part 1207 so that the ends 1413 and 1415 are over the slots 1507. As shown in FIG. 16B, the part 1205 is lowered so that the ends 1413 and 1415 are resting in the slots. As shown in FIG. 16C, once the ends are in the slots, the locking part is pivoted to the point that it locks the ends into the slots and is pinned with pin 1601 to keep it all together.

FIGS. 17A-D illustrate the movements accommodated by the joint with the towing vehicle. As seen in FIG. 17A, the bar 1205 is permitted to swing through a vertical plane because of the way the ends 1413 and 1415 can rotate within the slots 1507. Preferably, the swing is at least 90 degrees. As seen in FIG. 17B, because the bracket 1505 is rotatably mounted to the block 103, the rest of the tow bar is able to rotate about an axis parallel to a line between the towing and towed vehicles. This allows the towed vehicle to twist with respect to the towing vehicle. As seen in FIG. 17C, because the bar 1401 is attached to the bracket 1411 through the bolt 1405, the bar is free to swing horizontally, preferably through an angle of at least 120 degrees.

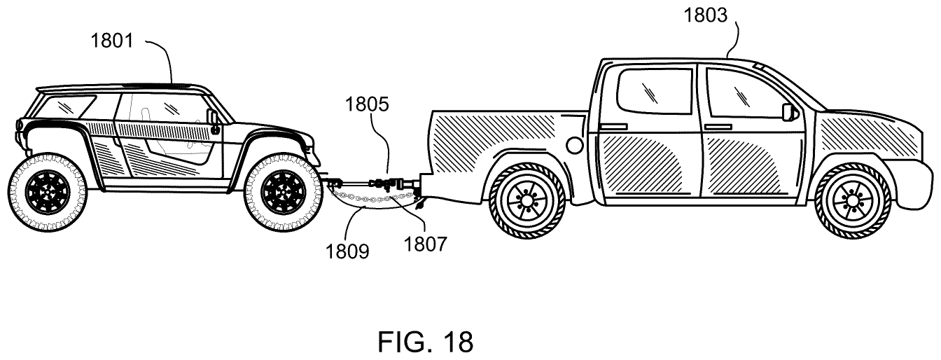

FIG. 18 depicts a towed vehicle 1801 attached to a towing vehicle 1803, through the tow bar system 1805. As required by most jurisdictions, a pair of safety chains 1807 is hooked between the towing vehicle and the towed vehicle. These chains serve to keep the two vehicles connected if there is a failure in some component of the tow bar system. Typically, the safety chains attach at one end to holes formed in the towing vehicles hitch assembly. The other ends of the chains are hooked to the towed vehicle, preferably one on each side of the tow bar. Sometimes, the chains are crisscrossed, so that the tow bar could be supported by the chains if it became unattached from the towing vehicle.

It is also preferable to include a break-away cable 1809 attached between the two vehicles. The purpose of this cable is to alert the driver of the towing vehicle if the towed vehicle becomes unattached. Preferably, the tow bar system also uses this break-away cable to automatically engage the brakes of the towed vehicle. Because regenerative braking cannot be relied on in every situation, it is best to engage a mechanical brake, perhaps a parking brake to stop the towed vehicle in this emergency situation. In order to avoid to sudden of a stop of the towed vehicle, this emergency braking may be programmed to occur over a predetermined length of time, say 5 seconds from when the break-away cord is separated.

All patents and applications referenced herein are incorporated in their entirety by this reference. The invention has been described with reference to various specific and preferred embodiments and techniques. Nevertheless, it is understood that many variations and modifications may be made while remaining within the spirit and scope of the invention.

What is claimed is:

1. A tow bar system for towing a vehicle comprising:
a towing vehicle connection member with a first tongue for insertion into a hitch receiver of a towing vehicle;
a towed vehicle connection member with a second tongue for insertion into a hitch receiver of a towed vehicle;
a bar attached at one end through a first joint to the towing vehicle connection member and attached at its other end through a second joint to the towed vehicle connection member;
wherein at least one of the first and second joints is configured to allow motion in both a horizontal and vertical direction; and
a wiring harness held on the tow bar, having a forward connector adapted to connect to wires in the towing vehicle and a rearward connector adapted to connect to wires in the towed vehicle.

2. The tow bar system of claim 1, wherein the first joint is configured to allow motion in both the horizontal and the vertical direction.

3. The tow bar of claim 2, wherein the first joint is a ball and socket joint.

4. The tow bar system of claim 2, wherein the first joint is configured to provide a horizontal pivot of at least 120 degrees and is configured to provide a vertical pivot of at least 90 degrees.

5. The tow bar system of claim 4, wherein the first joint allow allows rotation about an axis parallel to a line between the towing vehicle and the towed vehicle.

6. The tow bar system of claim 2, wherein the second joint is configured to only allow motion in the vertical direction.

7. The tow bar system of claim 6, wherein the second joint is configured to lock the bar in a vertical storage position when not in use.

8. The tow bar system of claim 1, wherein the wiring harness of the tow bar is adapted to pass a command from the towing vehicle to the towed vehicle.

9. The tow bar system of claim 8, wherein the towed vehicle further comprises at least one system for controlling the speed, direction, or indicator lights of the vehicle, and wherein the at least one system of the towed vehicle receives the command from the towing vehicle and executes the command.

10. The tow bar of claim 8, wherein the command instructs the at least one system of the towed vehicle to echo certain actions of the towing vehicle.

11. The tow bar of claim 8, wherein the command activates brake lights and turn signal lights in the towed vehicle.

12. The tow bar of claim 8, wherein the command activates brakes in the towed vehicle to assist in stopping the towing vehicle and towed vehicle.

13. The system of claim 12, wherein the towed vehicle is an electric vehicle powered by a battery, and wherein the brakes in the towed vehicle use regenerative braking to add charge to the battery.

14. The tow bar of claim 8, wherein the command activates at least one motor in the towed vehicle to assist in moving the towing vehicle and towed vehicle.

15. The tow bar of claim 8, wherein the command activates at least two motors in the towed vehicle, each motor at a different speed, to cause differential speed steering of the towed vehicle.

16. The tow bar of claim 1, wherein the towed vehicle is an electric vehicle powered by a first battery, wherein the towing vehicle is an electric vehicle by a second battery, and wherein the tow bar system comprises an electric cable for passing power between the first and second batteries.

17. The tow bar system of claim 1, further comprising a communication module for relaying instructions to and information about the towed vehicle to a smart device in the towing vehicle.

18. A tow bar system attached between a towing vehicle and a towed vehicle, comprising:
a towing vehicle connection member, comprising:
a first tongue for inserting into a hitch receiver on a back end of the towing vehicle;
a joint that allows rotation around an axis parallel to a line between the towing vehicle and the towed vehicle;
a bar, comprising:
a forward end configured to attach to the towing vehicle connection member in such a way to allow vertical pivot between the bar and the towing vehicle connection member;
a joint that allows a horizontal pivot between the forward end and a rearward end of the bar; and
a towed vehicle connection member, comprising:
a sleeve for receiving the rearward end of the bar;
a second tongue for inserting into a receiver hitch on a front end of the towed vehicle; and
a joint that allows pivoting in a vertical direction between the second tongue and the sleeve.

19. The tow bar system of claim 17, further comprising a wiring harness having a forward connector adapted to connect to wires in the towing vehicle and a rearward connector adapted to connect to wires in the towed vehicle.

20. The tow bar system of claim 18, wherein the wiring harness is configured to pass command signals from the towing vehicle to the towed vehicle.
